(19) United States
(12) Patent Application Publication
(10) Pub. No.: US 2013/0138897 A1
(43) Pub. Date: May 30, 2013

(54) METHOD AND APPARATUS FOR DYNAMICALLY CONTROLLING DEPTH AND POWER CONSUMPTION OF FIFO MEMORY

(71) Applicant: Jimshed B. Mirza, Toronto (CA)

(72) Inventor: Jimshed B. Mirza, Toronto (CA)

(73) Assignee: ATI TECHNOLOGIES ULC, Markham (CA)

(21) Appl. No.: 13/306,384

(22) Filed: Nov. 29, 2011

(51) Int. Cl. G06F 12/00

(52) U.S. Cl. 711/154; 711/E12.001

(57) ABSTRACT

A method and apparatus are described for controlling depth and power consumption of a first-in first-out (FIFO) memory including a data storage, a FIFO top register, a FIFO bottom register and control logic. The data storage may be segmented into a plurality of data storage segments. The FIFO top register may be configured to generate a first value indicating where a first entry in the data storage is stored. The FIFO bottom register may be configured to generate a second value indicating where a last entry in the data storage is stored. The control logic may be configured to determine which of the data storage segments to activate or deactivate based at least in part on the first and second values, and to monitor an available capacity and a write/read rate of the FIFO memory as data is read from and written to the activated data storage segments.

### FIELD OF INVENTION

This application is related to the design of first in, first out (FIFO) memory.

### BACKGROUND

First-in, first-out (FIFO) memory chips may be used in buffering applications between devices that operate at different speeds, or in applications where data must be temporarily stored in a buffer for further processing. Typically, this type of buffering may be used to increase bandwidth and to prevent data loss during high-speed communications. As the term FIFO implies, data is released from the buffer in the order of its arrival. In a synchronous FIFO memory, the same clock may be used for writing data to the FIFO memory and reading data from the FIFO memory. In an asynchronous FIFO memory, different clocks are used for writing and reading data. Depending on the device, FIFO memory may be unidirectional or bidirectional. FIFO memory may also include parallel inputs and outputs, as well as programmable flags.

FIFO memory may vary in terms of density, number of words, bits per word, supply voltage, and operating temperature. The density is the capacity of the chip in bits. The number of words equals the number of rows, each of which stores a memory word and connects to a word line for addressing purposes. Bits per word are the number of columns, each of which connects to a sense/write circuit. Supply voltages may range, for example, from −5 volts to +5 volts and include numerous intermediate voltages. Some FIFO memory chips may support a specific temperature range, and feature mechanical and electrical specifications that are suitable for commercial or industrial applications. Other FIFO memory chips meet screening levels for military specifications (MIL-SPEC).

The amount of throughput running through unused portions of FIFO memory in today's digital logic may vary substantially, depending on the type and quantity of workload. In the past, this has not posed a major problem, since the depth of a FIFO memory may be adjusted to handle the maximum theoretical workload. However, with the recent expansion in the use of mobile devices, and increasing emphasis on low power consumption, the availability of unused FIFO memory may cause power loss due to leakage.

### SUMMARY OF EMBODIMENTS

A method and apparatus are described for controlling depth and power consumption of a first-in first-out (FIFO) memory including a data storage, a FIFO top register, a FIFO bottom register and control logic. The data storage may be segmented into a plurality of data storage segments. The FIFO top register may be configured to generate a first value indicating where a first entry in the data storage is stored. The FIFO bottom register may be configured to generate a second value indicating where a last entry in the data storage is stored. The control logic may be configured to determine which of the data storage segments to activate or deactivate based at least in part on the first and second values.

An available capacity and a write/read rate of the FIFO memory may be monitored as data is read from and written to the activated data storage segments.

An average of the available capacity may be compared to a first threshold and a second threshold. At least one of the data storage segments that is currently activated may be deactivated if the average available capacity is below the first threshold. At least one of the data storage segments that is currently deactivated may be activated if the average available capacity is above the second threshold. The first value and the second value may be updated.

An average of the write/read rate may be compared to a first threshold and a second threshold. At least one of the data storage segments that is currently activated may be deactivated if the average write/read rate is below the first threshold. At least one of the data storage segments that is currently deactivated may be activated if the average write/read rate is above the second threshold.

In another embodiment, a method of controlling depth and power consumption of the FIFO memory may include monitoring a write/read rate of the FIFO memory as data is read from and written to the data storage, wherein the data storage includes a plurality of data storage segments, and determining which of the data storage segments to activate or deactivate based at least in part on an average of the write/read rate.

In another embodiment, a method of controlling depth and power consumption of the FIFO memory may include monitoring an available capacity of the FIFO memory as data is read from and written to the data storage, wherein the data storage includes a plurality of data storage segments, and determining which of the data storage segments to activate or deactivate based at least in part on an average of the available capacity.

A computer-readable storage medium may be configured to store a set of instructions used for manufacturing a semiconductor device comprising the FIFO memory in accordance with any of the embodiments described above. The instructions may be Verilog data instructions or hardware description language (HDL) instructions.

### BRIEF DESCRIPTION OF THE DRAWINGS

A more detailed understanding may be had from the following description, given by way of example in conjunction with the accompanying drawings wherein:

FIG. 1 is a block diagram of an example power-gated FIFO memory in which power to the data storage of the FIFO memory is turned on or off;

FIG. 2 is a block diagram of an example power-efficient FIFO memory in which segments of the data storage of the FIFO memory are selectively turned on or off based on various thresholds and parameters;

FIGS. 3A, 3B and 3C, taken together, are a flow diagram of a procedure for controlling the depth and power of the data storage of the FIFO memory of FIG. 2;

FIG. 4A is a block diagram of an example device in which one or more disclosed embodiments may be implemented; and

FIG. 4B is a block diagram of an alternate example device in which one or more disclosed embodiments may be implemented.

### DETAILED DESCRIPTION OF EMBODIMENTS

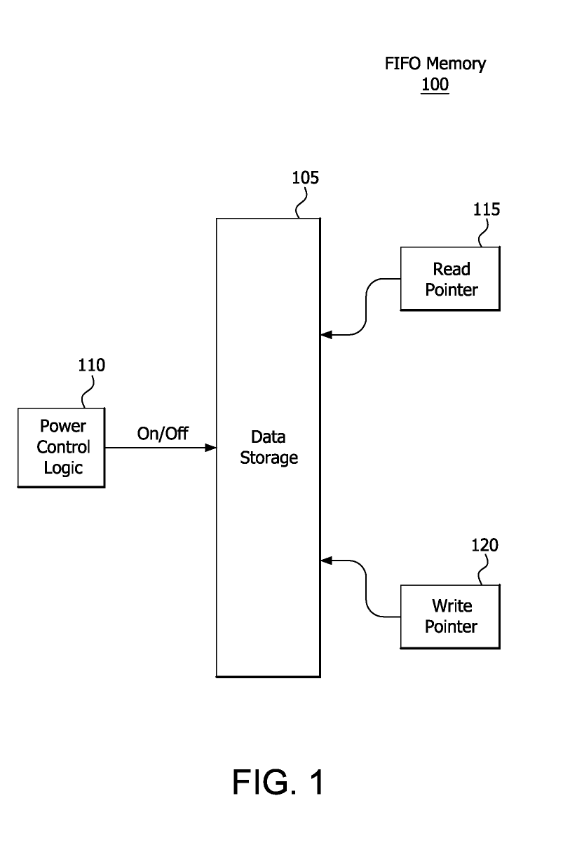

FIG. 1 shows a block diagram of a FIFO memory 100 including data storage 105 and power control logic 110. Typically, the FIFO memory 100 is memory macro-based or flip-flop-based with a read pointer 115 and a write pointer 120. Power to the data storage 105 of the FIFO memory 100 is turned on or off by the power control logic 110. Thus, the entire data storage 105 is powered on, even when only a small portion of the data storage 110 is being used.

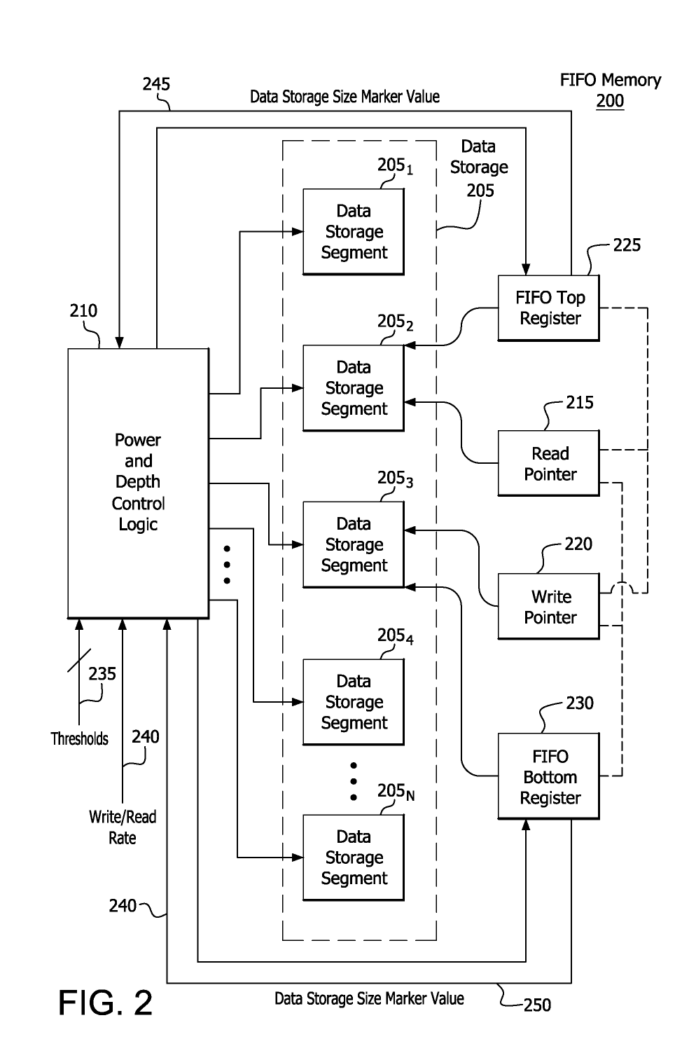

FIG. 2 is a block diagram of a power-efficient FIFO memory 200 that includes a data storage 205, power and depth control logic 210, a read pointer 215, a write pointer 220, a FIFO top register 225, and a FIFO bottom register 230. The data storage 205 may be segmented into a plurality of data storage segments 205₁, 205₂, 205₃, 205₄, . . . , 205_{N}, each of which may be selectively activated (i.e., powered on) or deactivated (i.e., powered off) on an individual basis in accordance with a variety of workload thresholds 235, write/read rate 240, a data storage size marker value 245 generated by the FIFO top register 225, and a data storage size marker value 250 generated by the FIFO bottom register 230 that are input into the power and depth control logic 210. Alternatively, respective ones of the data storage segments 205₁-205_{N} may be assigned to particular data storage segment groups that may be selectively activated (i.e., powered on) or deactivated (i.e., powered off) on a group basis in accordance with a variety of workload thresholds 235, write/read rate 240, and the data storage size marker values 245 and 250.

As mentioned above, the data store size marker values 245 and 250 may be generated by the registers 225 and 230, respectively. Alternatively, the registers 225 and 230 may be populated with marker values 245 and 250 by other logic that may be part of the FIFO memory 200 or another device.

The power-efficient FIFO memory 200 of FIG. 2 may be resized dynamically such that unused segments of the data storage 205 may be individually deactivated to reduce power consumption of the FIFO memory 200, depending on the workload, so as to minimize leakage.

The FIFO top register 225 and the FIFO bottom register 230 provide respective data storage size marker values 245 and 250 to indicate the top and bottom of the portion of the data storage 205 that is currently being used. For example, the FIFO top register 225 may indicate that the first entry in the data storage 205 is stored in the data storage segment 205₂, and the FIFO bottom register 230 may indicates that the last entry in the data storage 205 is stored in the data storage segment 205₃. Thus, in the example of FIG. 2, only the segments 205₂ and 205₃ of the data storage 205 are currently being used by the read pointer 215 and the write pointer 220, and the control logic 210 may be configured to deactivate the remaining segments of the data storage 205 (205₁ and 205₄-205_{N}) to reduce the capacity and power consumption of the data storage 205.

The FIFO memory 200 may be implemented as a circular buffer so that when a pointer is on its bottom marker, the next time it moves forward it may jump to its top marker, otherwise known as wraparound. The read pointer 215 and the write pointer 220 may use the data storage size marker values 245 and 250 to determine when to wraparound. For example, a 256 deep data storage, (i.e., a data storage capable of storing 256 entries), may be segmented into four 64 deep data storage segments. The power to each of these segments may be individually controlled by the control logic 210. The control logic 210 determines the desirable depth, (i.e., the number of desired activated data storage segments), based on the current workload of the FIFO memory 200, and then changes the data storage size marker value 245 of the FIFO top register 225 and data storage size marker value 250 of the FIFO bottom register 230 accordingly. The segments of the data storage 205 that lie outside of the marker values 245 and 250 may then be deactivated.

If the control logic 210 determines, based on the data storage size marker values 245 and 250, that the data storage 205 is frequently hitting a “full” condition where there is no additional storage capacity, one or more of the segments of the data storage 205 may be activated and the size marker values 245 and 250 may be adjusted to increase the depth of the data storage 205. The increase in the number of activated segments of the data storage 205 may be implemented such that only one additional segment of the data storage 205 is activated at a time to reduce the frequency of the data storage 205 reaching a full condition often.

In one embodiment, a method of controlling depth and power consumption of the FIFO memory 200 may include generating a first value (245) indicating where a first entry in the data storage 205 is stored, generating a second value (250) indicating where a last entry in the data storage 205 is stored, and determining which of a plurality of segments 205₁-205_{N} of the data storage 205 to activate or deactivate based at least in part on the first value 245 and the second value 250.

An available capacity and a write/read rate of the FIFO memory 200 may be monitored as data is read from and written to the activated data storage segments 205₁-205_{N}. An average of the available capacity may be compared to a first threshold and a second threshold. At least one of the data storage segments 205₁-205_{N} that is currently activated may be deactivated if the average available capacity is below the first threshold. At least one of the data storage segments 205₁-205_{N} that is currently deactivated may be activated if the average available capacity is above the second threshold. The first value (245) and the second value (250) may be updated.

An average of the write/read rate may be compared to a first threshold and a second threshold. At least one of the data storage segments 205₁-205_{N} that is currently activated may be deactivated if the average write/read rate is below the first threshold. At least one of the data storage segments 205₁-205_{N} that is currently deactivated may be activated if the average write/read rate is above the second threshold. The first value (245) and the second value (250) may be updated.

In another embodiment, a method of controlling depth and power consumption of the FIFO memory 200 may include monitoring a write/read rate of the FIFO memory 200 as data is read from and written to the data storage 205, wherein the data storage 205 includes a plurality of data storage segments 205₁-205_{N}, and determining which of the data storage segments 205₁-205_{N} to activate or deactivate based at least in part on an average of the write/read rate.

In another embodiment, a method of controlling depth and power consumption of the FIFO memory 200 may include monitoring an available capacity of the FIFO memory 200 as data is read from and written to the data storage 205, wherein the data storage 205 includes a plurality of data storage segments 205₁-205_{N}, and determining which of the data storage segments 205₁-205_{N} to activate or deactivate based at least in part on an average of the available capacity.

The FIFO memory 200 may comprise the data storage 205 including the plurality of data storage segments 205₁-205_{N}, the FIFO top register 225 configured to generate a first value (245) indicating where a first entry in the data storage 205 is stored, the FIFO bottom register 230 configured to generate a second value (250) indicating where a last entry in the data storage 205 is stored, and the control logic 210 configured to determine which of the data storage segments 205₁-205_{N} to activate or deactivate based at least in part on the first and second values.

The control logic 210 may be further configured to monitor an available capacity and a write/read rate of the FIFO memory 200 as data is read from and written to the activated data storage segments 205₁-205_{N}.

The control logic 210 may be further configured to compare an average of the available capacity to a first threshold and a second threshold, deactivate at least one of the data storage segments 205₁-205_{N} that is currently activated if the average available capacity is below the first threshold, activate at least one of the data storage segments 205₁-205_{N} that is currently deactivated if the average available capacity is above the second threshold, and update the first value (245) and the second value (250).

The control logic 210 may be further configured to compare an average of the write/read rate to a first threshold and a second threshold, deactivate at least one of the data storage segments 205₁-205_{N} that is currently activated if the average write/read rate is below the first threshold, activate at least one of the data storage segments 205₁-205_{N} that is currently deactivated if the average write/read rate is above the second threshold, and update the first value (245) and the second value (250).

The FIFO memory 200 may comprise the data storage 205 including a plurality of data storage segments 205₁-205_{N}, and the control logic 210 configured to monitor a write/read rate of the FIFO memory 200 as data is read from and written to the data storage 205, and determine which of the data storage segments 205₁-205_{N} to activate or deactivate based at least in part on an average of the write/read rate.

The control logic 210 may be further configured to compare an average of the write/read rate to a first threshold and a second threshold, deactivate at least one of the data storage segments 205₁-205_{N} that is currently activated if the average write/read rate is below the first threshold, and activate at least one of the data storage segments 205₁-205_{N} that is currently deactivated if the average write/read rate is above the second threshold.

The FIFO memory 200 may comprise the data storage 200 including a plurality of data storage segments 205₁-205_{N}, and the control logic 210 configured to monitor an available capacity of the FIFO memory 200 as data is read from and written to the data storage 205, and determine which of the data storage segments 205₁-205_{N} to activate or deactivate based at least in part on an average of the available capacity.

A computer-readable storage medium may be configured to store a set of instructions used for manufacturing a semiconductor device comprising the FIFO memory 200 in accordance with any of the embodiments described above. The instructions may be Verilog data instructions or hardware description language (HDL) instructions.

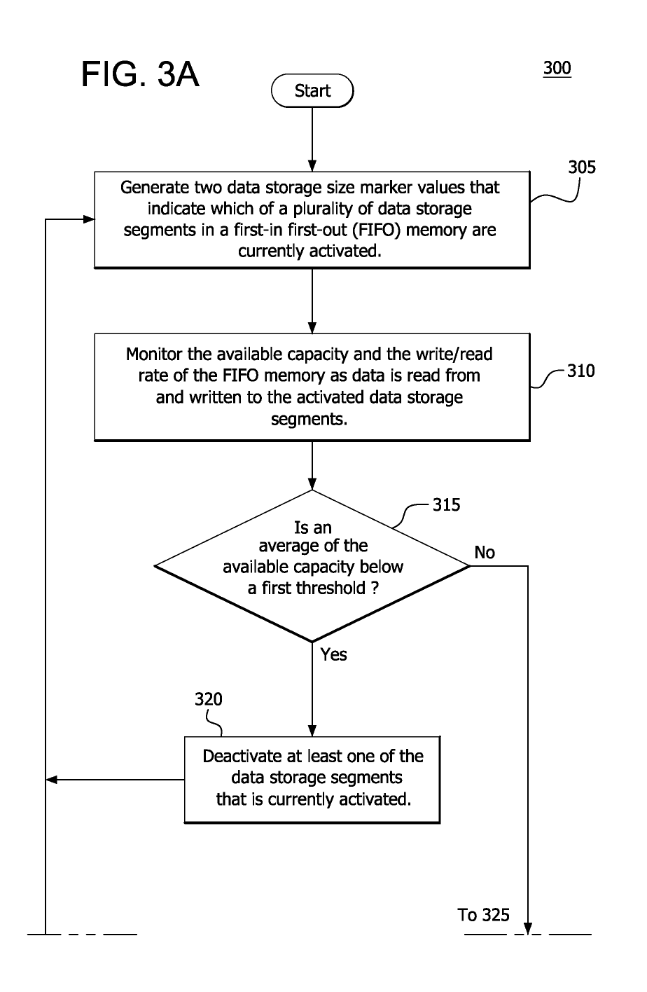

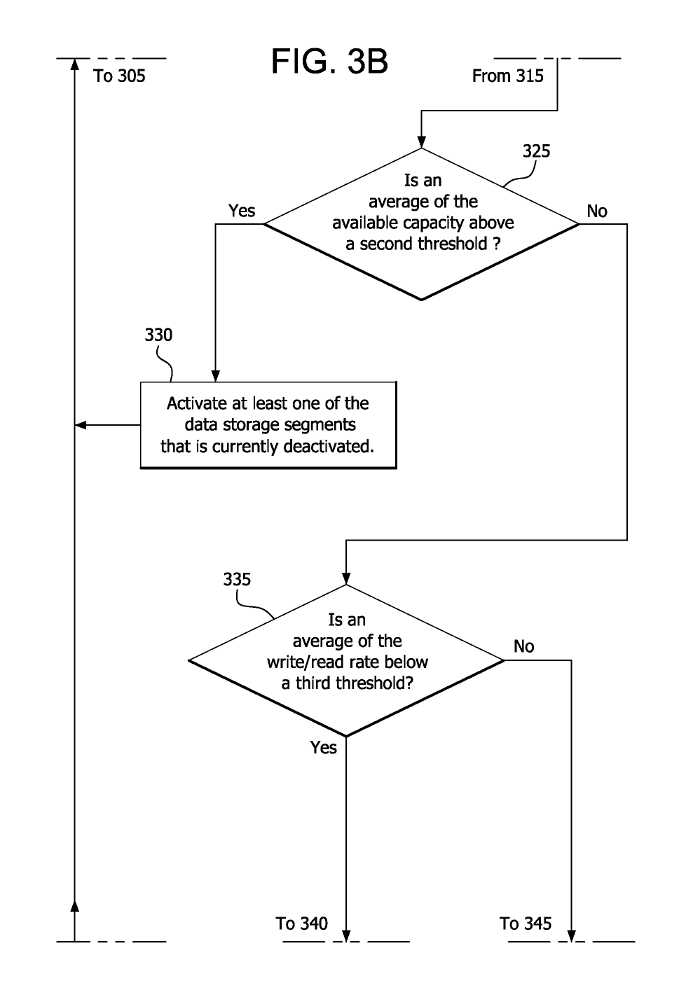

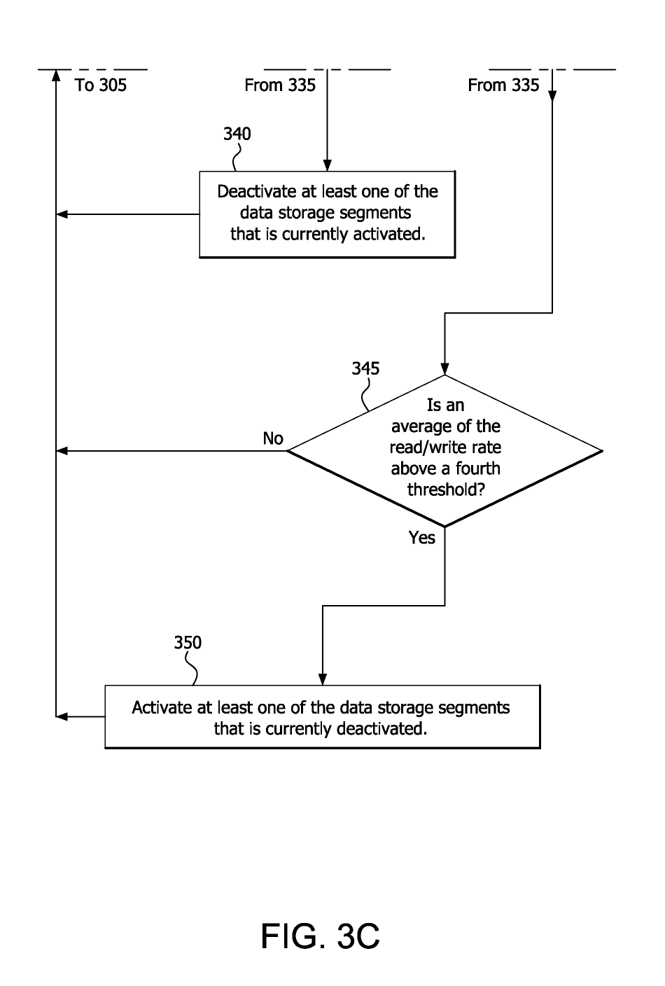

FIGS. 3A, 3B and 3C, taken together, are a flow diagram of a procedure for controlling the depth and power of the data storage 205 of the FIFO memory 200 of FIG. 2. As shown in FIG. 3A, two data storage size marker values are generated that indicate which of a plurality of data storage segments in a FIFO memory are currently activated (305). The available capacity and the write/read rate of the FIFO memory is monitored as data is read from and written to the activated data storage segments (310). A determination is made as to whether an average of the available capacity of the FIFO memory is below a first threshold (315). If it is determined that the average of the available capacity of the FIFO memory is below a first threshold, at least one of the currently activated data storage segments in the FIFO memory is deactivated (320) and the procedure 300 returns to step 305.

As shown in FIG. 3B, if it is determined that the average of the available capacity of the FIFO memory is not below a first threshold, a determination is made as to whether the average of the available capacity of the FIFO memory is above a second threshold (325). If it is determined that the average of the available capacity of the FIFO memory is above a second threshold, at least one of the currently deactivated data storage segments in the FIFO memory is activated (330) and the procedure 300 returns to step 305. If it is determined that the average of the available capacity of the FIFO memory is not above a second threshold, a determination is made as to whether the average of the write/read rate of the FIFO memory is below a third threshold (335).

As shown in FIG. 3C, if it is determined that the average of the write/read rate of the FIFO memory is below a third threshold, at least one of the currently activated data storage segments in the FIFO memory is deactivated (340) and the procedure 300 returns to step 305. If it is determined that the average of the write/read rate of the FIFO memory is not below a third threshold, a determination is made as to whether the average of the write/read rate of the FIFO memory is above a fourth threshold (345). If it is determined that the average of the write/read rate of the FIFO memory is not above a fourth threshold, the procedure 300 returns to step 305. If it is determined that the average of the write/read rate of the FIFO memory is above the fourth threshold, at least one of the currently deactivated data storage segments in the FIFO memory is activated (350) and the procedure 300 returns to step 305.

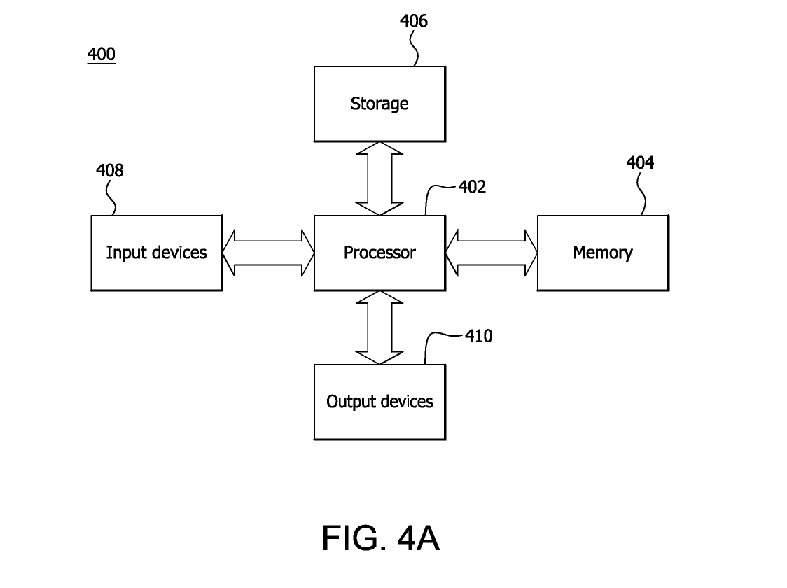

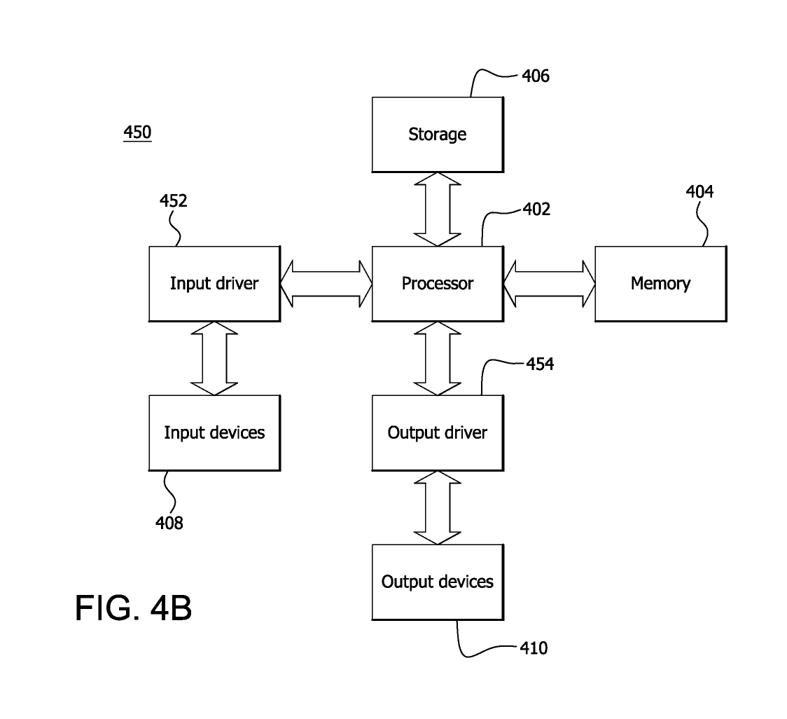

FIG. 4A is a block diagram of an example device 400 in which one or more disclosed embodiments may be implemented. The device 400 may include, for example, a computer, a gaming device, a handheld device, a set-top box, a television, a mobile phone, or a tablet computer. The device 400 includes a processor 402, a memory 404 having a similar configuration as the FIFO memory 200 of FIG. 2, a storage 406, one or more input devices 408, and one or more output devices 410. It is understood that the device 400 may include additional components not shown in FIG. 4A.

The processor 402 may include a central processing unit (CPU), a graphics processing unit (GPU), a CPU and GPU located on the same die, one or more processor cores, wherein each processor core may be a CPU or a GPU. The memory 404 may be located on the same die as the processor 402, or may be located separately from the processor 404. The memory 404 may include a volatile or non-volatile memory, for example, random access memory (RAM), dynamic RAM, or a cache.

The storage 406 may include a fixed or removable storage, for example, hard disk drive, solid state drive, optical disk, or flash drive. The input devices 408 may include a keyboard, a keypad, a touch screen, a touch pad, a detector, a microphone, an accelerometer, a gyroscope, a biometric scanner, or a network connection, (e.g., a wireless local area network card for transmission and/or reception of wireless IEEE 802 signals). The output devices 410 may include a display, a speaker, a printer, a haptic feedback device, one or more lights, an antenna, or a network connection, (e.g., a wireless local area network card for transmission and/or reception of wireless IEEE 802 signals).

FIG. 4B is a block diagram of an alternate example device 450 in which one or more disclosed embodiments may be implemented. Elements of the device 450 which are the same as in the device 400 are given like reference numbers. In addition to the processor 402, the memory 404, the storage 406, the input devices 408, and the output devices 410, the device 450 also includes an input driver 452 and an output driver 454.

The input driver 452 communicates with the processor 402 and the input devices 408, and permits the processor 402 to receive input from the input devices 408. The output driver 454 communicates with the processor 402 and the output devices 410, and permits the processor 402 to send output to the output devices 410.

Although features and elements are described above in particular combinations, each feature or element can be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), an accelerated processing unit (APU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A method of controlling depth and power consumption of a first-in first-out (FIFO) memory, the method comprising:
generating a first value indicating where a first entry in a data storage of the FIFO memory is stored;
generating a second value indicating where a last entry in the data storage is stored; and
determining which of a plurality of segments of the data storage to activate or deactivate based at least in part on the first value and the second value.

2. The method of claim 1 further comprising:
monitoring an available capacity and a write/read rate of the FIFO memory as data is read from and written to the activated data storage segments.

3. The method of claim 2 further comprising:
comparing an average of the available capacity to a first threshold and a second threshold;
deactivating at least one of the data storage segments that is currently activated if the average available capacity is below the first threshold;
activating at least one of the data storage segments that is currently deactivated if the average available capacity is above the second threshold; and
updating the first value and the second value.

4. The method of claim 2 further comprising:
comparing an average of the write/read rate to a first threshold and a second threshold;
deactivating at least one of the data storage segments that is currently activated if the average write/read rate is below the first threshold;
activating at least one of the data storage segments that is currently deactivated if the average write/read rate is above the second threshold; and
updating the first value and the second value.

5. A method of controlling depth and power consumption of a first-in first-out (FIFO) memory, the method comprising:
monitoring a write/read rate of the FIFO memory as data is read from and written to a data storage of the FIFO memory, wherein the data storage includes a plurality of data storage segments; and
determining which of the data storage segments to activate or deactivate based at least in part on an average of the write/read rate.

6. The method of claim 5 further comprising:
comparing an average of the write/read rate to a first threshold and a second threshold;
deactivating at least one of the data storage segments that is currently activated if the average write/read rate is below the first threshold; and
activating at least one of the data storage segments that is currently deactivated if the average write/read rate is above the second threshold.

7. A method of controlling depth and power consumption of a first-in first-out (FIFO) memory, the method comprising:
monitoring an available capacity of the FIFO memory as data is read from and written to a data storage of the FIFO memory, wherein the data storage includes a plurality of data storage segments; and
determining which of the data storage segments to activate or deactivate based at least in part on an average of the available capacity.

8. The method of claim 7 further comprising:
comparing an average of the available capacity to a first threshold and a second threshold;
deactivating at least one of the data storage segments that is currently activated if the average available capacity is below the first threshold; and
activating at least one of the data storage segments that is currently deactivated if the average available capacity is above the second threshold.

9. A first-in first-out (FIFO) memory comprising:
a data storage including a plurality of data storage segments;
a FIFO top register configured to generate a first value indicating where a first entry in the data storage is stored;
a FIFO bottom register configured to generate a second value indicating where a last entry in the data storage is stored; and
control logic configured to determine which of the data storage segments to activate or deactivate based at least in part on the first value and the second value.

10. The FIFO memory of claim 9 wherein the control logic is further configured to monitor an available capacity and a write/read rate of the FIFO memory as data is read from and written to the activated data storage segments.

11. The FIFO memory of claim 10 wherein the control logic is further configured to compare an average of the available capacity to a first threshold and a second threshold, deactivate at least one of the data storage segments that is currently activated if the average available capacity is below the first threshold, activate at least one of the data storage segments that is currently deactivated if the average available capacity is above the second threshold, and update the first and second values.

12. The FIFO memory of claim 10 wherein the control logic is further configured to compare an average of the write/read rate to a first threshold and a second threshold, deactivate at least one of the data storage segments that is currently activated if the average write/read rate is below the first threshold, activate at least one of the data storage segments that is currently deactivated if the average write/read rate is above the second threshold, and update the first and second values.

13. A first-in first-out (FIFO) memory comprising:
a data storage including a plurality of data storage segments; and
control logic configured to monitor a write/read rate of the FIFO memory as data is read from and written to the data storage, and determine which of the data storage segments to activate or deactivate based at least in part on an average of the write/read rate.

14. The FIFO memory of claim 13 wherein the control logic is further configured to compare an average of the write/read rate to a first threshold and a second threshold, deactivate at least one of the data storage segments that is currently activated if the average write/read rate is below the first threshold, and activate at least one of the data storage segments that is currently deactivated if the average write/read rate is above the second threshold.

15. A first-in first-out (FIFO) memory comprising:
a data storage including a plurality of data storage segments; and
control logic configured to monitor an available capacity of the FIFO memory as data is read from and written to the data storage, and determine which of the data storage segments to activate or deactivate based at least in part on an average of the available capacity.

16. The FIFO memory of claim 15 wherein the control logic is further configured to compare an average of the available capacity to a first threshold and a second threshold, deactivate at least one of the data storage segments that is currently activated if the average available capacity is below the first threshold, and activate at least one of the data storage segments that is currently deactivated if the average available capacity is above the second threshold.

17. A computer-readable storage medium configured to store a set of instructions used for manufacturing a semiconductor device, wherein the semiconductor device comprises:
a data storage including a plurality of data storage segments;
a first-in first-out (FIFO) top register configured to generate a first value indicating where a first entry in the data storage is stored;
a FIFO bottom register configured to generate a second value indicating where a last entry in the data storage is stored; and
control logic configured to determine which of the data storage segments to activate or deactivate based at least in part on the first value and the second value.

18. The computer-readable storage medium of claim 17 wherein the instructions are Verilog data instructions.

19. The computer-readable storage medium of claim 17 wherein the instructions are hardware description language (HDL) instructions.

20. A computer-readable storage medium configured to store a set of instructions used for manufacturing a semiconductor device, wherein the semiconductor device comprises:
a data storage including a plurality of data storage segments; and
control logic configured to monitor a write/read rate of the semiconductor device as data is read from and written to the data storage, and determine which of the data storage segments to activate or deactivate based at least in part on an average of the write/read rate.

21. The computer-readable storage medium of claim 20 wherein the instructions are Verilog data instructions.

22. The computer-readable storage medium of claim 20 wherein the instructions are hardware description language (HDL) instructions.

23. A computer-readable storage medium configured to store a set of instructions used for manufacturing a semiconductor device, wherein the semiconductor device comprises:
a data storage including a plurality of data storage segments; and
control logic configured to monitor an available capacity of the semiconductor device as data is read from and written to the data storage, and determine which of the data storage segments to activate or deactivate based at least in part on an average of the available capacity.

24. The computer-readable storage medium of claim 23 wherein the instructions are Verilog data instructions.

25. The computer-readable storage medium of claim 23 wherein the instructions are hardware description language (HDL) instructions.
